(19) United States
(12) Patent Application Publication
(10) Pub. No.: US 2013/0234508 A1
(43) Pub. Date: Sep. 12, 2013

(54) APPARATUS FOR USE IN AN ELECTRICAL DRIVE SYSTEM, AND METHOD FOR OPERATING AN APPARATUS OF THIS KIND

(71) Applicants: Markus Eisele, Friedrichshafen (DE); Yvonne Wiegand, Nuernberg (DE); Stefan Heimpel, Sigmarszell (DE); Maximilian Wagner, Weissensberg (DE)

(72) Inventors: Markus Eisele, Friedrichshafen (DE); Yvonne Wiegand, Nuernberg (DE); Stefan Heimpel, Sigmarszell (DE); Maximilian Wagner, Weissensberg (DE)

(73) Assignee: ZF FRIEDRICHSHAFEN AG, Friedrichshafen (DE)

(21) Appl. No.: 13/885,325

(22) PCT Filed: Nov. 7, 2011
(86) PCT No.: PCT/EP2011/069510

§ 371 Date: May 14, 2013

(30) Foreign Application Priority Data
Dec. 1, 2010 (DE) 10 2010 062 249.4

(51) Int. Cl. B60L 11/18

(52) U.S. Cl. CPC B60L 11/1803
USPC 307/9.1

(57) ABSTRACT

A device and a method of using the device in an electric drive system, particularly in a hybrid drive system of a motor vehicle. The device has at least a first and second battery system, connected in parallel, where their load outputs are connect to a common load output. Each battery system has an energy storage and a pre-charging circuit which is linked to it such that, by way of an output of the pre-charging circuit, the load output of the battery systems is created. The load output of each battery system can be connected or disconnected by way of the pre-charging circuit at the common load output. The common load output is energetically linked directly to an input of an inverter of the device by way of an intermediate circuit capacitor.

This application is a National Stage completion of PCT/EP2011/069510 filed Nov. 7, 2011, which claims priority from German patent application serial no. 10 2010 062 249.4 filed Dec. 1, 2010.

### FIELD OF THE INVENTION

The present invention concerns a device for the operating of an electrical drive system, as well as a method for operating the apparatus.

### BACKGROUND OF THE INVENTION

The future might show, especially in the center of cities, that there will be more often so-called “zero emission zones”. These are areas in which only vehicles can drive which do not create any emission when driving. For instance, busses and delivery trucks need to be operated in a pure electric mode.

In vehicles with a parallel hybrid drive, besides the so called hybrid driving in which the combustion engine as well as the electric assembly drive the vehicle, there is among other things the possibility to operate exclusively with the electric machine and the combustion engine turned off, thus free of emission. To drive for a sufficient distance in a pure electric mode, sufficient electric energy has to be provided in one or several energy storage devices.

Also known are so-called plug-in-hybrid vehicles where their battery is not only charged through recuperation of braking energy, for instance through regenerative braking, or the combustion engine, but can also be charged in addition through the electric power grid by means of an external charging station. Plug-in-hybrid vehicles combine the advantages of electric vehicles and pure combustion engine vehicles. On one hand, one can for instance in a city, in an environmental zone, drive in pure electric mode and therefore emission and noise free, and on the other hand, longer distances can be achieved by means of a combustion engine even if the battery is at a low charge state.

Up to now, partially due to large development cost, there are no suitable batteries to achieve larger distances in a pure electric operation. These would have to provide a high energy content, in addition a large power capacity to guarantee the required drive dynamics in a pure electric operation.

The currently available batteries for hybrid vehicles are, however, designed in a way to absorb and to output recuperation energy, meaning that their life expectancy lowers drastically at large energy increases which are needed for a pure electric drive. Because these batteries are very expensive they, as single device, are not suitable to be applied continuously for a pure electric drive.

The state of the art therefore suggests connecting several batteries in parallel by means of the power electronics to increase the energy content and the performance ability. Such a procedure is for instance described in detail in the publication DE 10 2007 009 009 A1. The main disadvantage of a parallel circuit is, however, the control ability. Different internal resistances, due to the manufacturing or which are created by different temperatures, cause asymmetrical behavior of the batteries in an operation. These facts result in a larger decrease of the electrical distance and the powering performance. For the control, and therefore the prevention of an asymmetrical behavior of batteries which are connected in parallel, intermediate circuits are required which need to be designed physically large and heavy, to switch high currents which flow in this configuration.

### SUMMARY OF THE INVENTION

Based on these facts, the present invention has the task to overcome the above mentioned disadvantages of the state of the art and to propose a device, as well as a method, which enables with little effort to run in parallel, batteries and battery systems without an intermediate circuit to an electronic inverter

The invention proposes a device to be used in an electric drive system, in particular in a hybrid drive system of a motor vehicle, comprising of at least a first and a second battery system configured in a parallel connection, where their load outputs are joined in a common load output, whereby each battery system has an energy storage and with it a connected pre-load circuit, whereby through an output of the pre-load circuit in each case the load output of the battery system is created, whereby the load output of each battery system, by means of the pre-load circuit, can each be connected or disconnected at the common load output, whereby the common load output is immediately then electrically coupled with an inverter input of an inverter of the device, in particular by means of an intermediate circuit capacitor.

In an embodiment of the inventive device, the load output of each battery system can be connected or disconnected by means of a battery management system of the battery system, whereby the battery management system controls in particular the pre-load circuit and/or a contactor.

In an additional embodiment of the inventive device, the battery management system is in an operational connection with a control unit of the device, in particular a hybrid control device.

In another embodiment of the inventive device, it is designed to alternately switch the load outputs of at least the first and/or second battery system to the common load output.

In accordance with the invention, a method is proposed for the operation of an inventive device, in particular in an electric drive system, and further in a hybrid drive system, whereby in a first step a first battery system, in particular depending on the load state of its energy storage, is disconnected from the common load output by means of its pre-load device, whereby in a second step a second battery system is connected to the common load output by means of its pre-load device, in particular depending of the load state of its energy storage.

Also proposed is a method in which the disconnection of the first battery systems from common load output and/or the connection of the second or further the battery systems to the common load output during operation of the inverter, especially for propulsion purposes, takes place.

In accordance with the aspect of the invented method, one of the several battery systems is always connected at the common load output during the operation of the converter, in particular before the first step and after the second step.

In accordance with an additional aspect of the invented method, the connection of the battery system and the second step takes place through an increase of an inverted input voltage by means of the pre-load device of the added battery system.

In accordance with another aspect of the invented method, a battery system is added in the second step if its energy storage has a higher charged level than the energy storage which was connected in the first step.

A method is also proposed in accordance with the invention whereby, at least for the duration of the first and second step, a third of the battery systems is connected in parallel to the common load output, in particular for the stabilization of an inverter input voltage, whereby the third of the battery systems is connected or disconnected by means of its pre-load device.

In addition, a method is also proposed in accordance with the invention, whereby during energy feedback, via an inverter, into the common load output for the purpose of charging an energy storage, in the first step, a battery system is disconnected from the common load output, where its energy storage shows a first, large charge state, and that in the second step a battery system is connected to the common load output where its energy storage has a lower charge state compared to the energy storage of the disconnected battery system.

In accordance with an aspect of the inventive method, the battery system which is added in the second step is selected, depending on the load state of its energy storage, from a multitude of battery systems which can be connected to the common load output.

In accordance with the invention, also a motor vehicle as proposed, in particular a plug-in-hybrid motor vehicle with the inventive device.

Additional characteristics and advantages of the invention arise from the following description of embodiment examples of the invention, based on the figures and drawings which show the inventive details. The individual characteristics can be enabled individually or together in any combination in a variation of the invention.

### BRIEF DESCRIPTION OF THE DRAWINGS

Embodiment examples of the invention are explained in the following based on the provided drawings. These show:

FIG. 1 as an example, a battery system forming the inventive device in accordance with a possible embodiment of the invention;

FIG. 2 as an example, a device to execute the inventive method in accordance with a possible embodiment of the invention.

### DETAILED DESCRIPTION OF THE PREFERRED EMBODIMENTS

In the following description of the drawings, same elements or functions, respectively, are marked with the same reference characters.

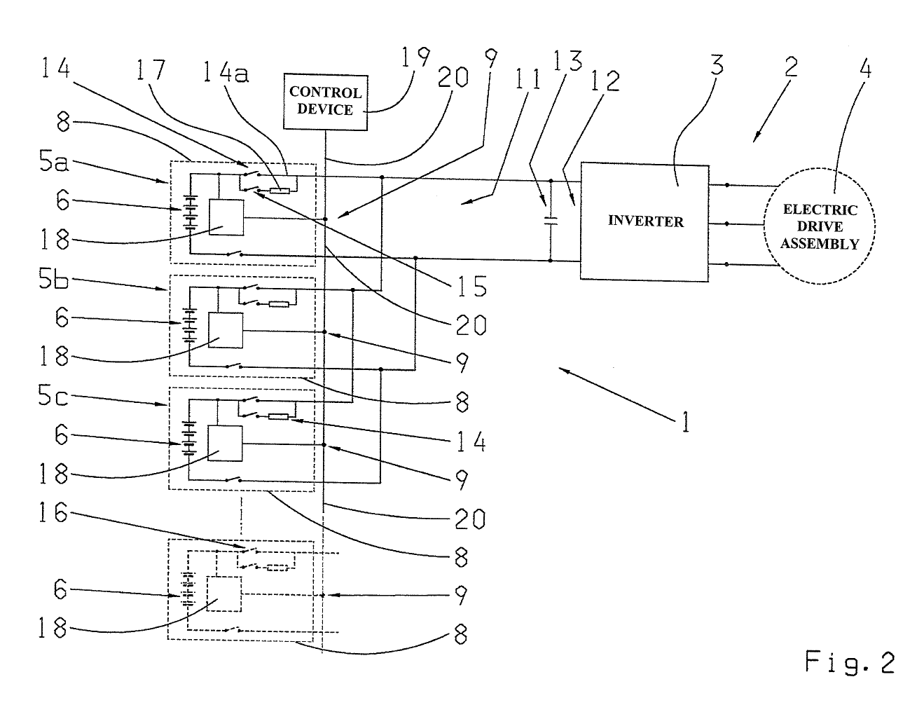

FIG. 2 shows as an example and schematically an inventive device 1 for use in electric drive system 2, in particular for a hybrid motor vehicle and more particularly for a plugin-hybrid-motor vehicle. The device 1 has an inverter 3, in particular a voltage inverter which is provided for the connection with an electric drive assembly 4 of the drive system 2, for instance with an induction machine. To drive the assembly 4, the inverter 3 is operated for instance with a pulse width modulation (PWM). The inverter 3 has, besides power switches which are assembled by means of power semiconductor parts, for instance a control device for the power semiconductor parts of the power switch.

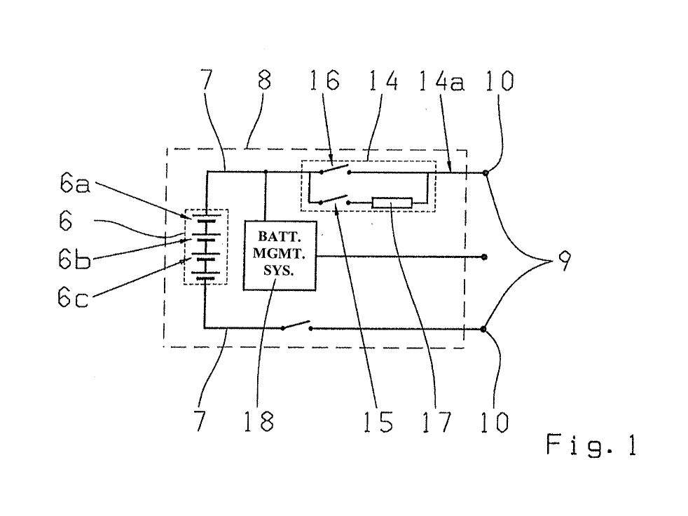

The device 1 according to the invention also has several, in particular similar battery systems 5a, 5b, 5c, . . . , at least a first 5a battery system and a second 5b battery system each of which comprises or has an energy storage 6, for instance FIG. 1. The energy storage 6 of a battery system 5a, 5b, 5c can each be configured by means of several partial energy storages 6a, 6b, 6c, or as a single energy storage 6. The energy storage 6 or the partial energy storages 6a, 6b, 6c, . . . are designed as a battery cell, as an alternative for instance as a fuel cell or as a super-capacitor. Several partial energy storages 6a, 6b, 6c, . . . can be configured for instance in parallel or, as shown, in series to create the energy storage 6.

A battery system 5a, 5b, 5c, . . . , in accordance with the invention, is designed in particular with an energy storage 6 as an accumulator, in particular as a traction battery. The stored energy is available at an output 7 of the energy storage 6, i.e. between the electrical connections, whereby each battery system 5a, 5b, 5c, . . . in particular provides a DC voltage.

A battery system 5a, 5b, 5c, . . . has for instance a housing 8 in which its components are protected and isolated against environmental conditions, respectively, and each has also an electrical output, i.e. a load output 9, through which the energy of the energy storage 6 is withdrawn, i.e. an output at the load side. The load output 9 is each in particular configured by means of two connection terminals 10 of a battery system 5a, 5b, 5c, . . . which can, for instance, extend out from the housing 8.

It is provided, in accordance with FIG. 2 of the invention, that at least a first and a second battery system 5a, 5b are connected in parallel to create the inventive device, in particular more than two battery systems 5a, 5b, 5c, . . . , whereby the load outputs 9 of the battery systems 5a, 5b, 5c, . . . are joined in a common load output 11, i.e. electrically. Such a created common load output 11 is, according to the invention, directly energetically or rather immediately, connected with the inverter input 12 of the inverter 3 of the device, meaning without the power electronics which is connected between the common load output 11 and the inverter 3.

An intermediate circuit capacitor 13 is implemented at the input 12 of the inverter 3 for the energy coupling, in particular by means of at least one intermediate circuit capacitor 13. The coupling element or intermediate circuit capacitor 13, respectively, is especially provided to store the energy, or to intermediately store it, which is provided by means of the common load output 11, to provide the inverter 3 with energy, as needed, to drive an electric drive assembly, for instance with a required voltage level. The coupling element 13 is in particular connected between the input terminals 3a of the inverter 3.

In addition, each battery system 5a, 5b, 5c, . . . has, in accordance with the invention, a pre-charging circuit 14 which can be, in particular, an integral part of each battery system 5a, 5b, 5c, . . . or be assigned to it. The pre-charging circuit 14 is hereby utilized to limit the high charging current which is present at the coupling or rather the energy storage element 13 which is positioned at the common load output 11. By means of each pre-charging circuit 14, the inverter input voltage can be selectively raised to the voltage level of a battery system 5a, 5b, 5c, . . . which needs to be connected electrically with the common load output 11, without a defect.

In accordance with the invention, a pre-charging circuit 14 is, in each case, coupled with the energy storage 6 of the battery system 5a, 5b, 5c . . . , i.e. electrically, wherein, by way of an output 14a of the pre-charging circuit 14, the load output 9 of a battery system 5a, 5b, 5c, . . . is, in each case, created. The pre-charging circuit 14 has, in a commonly known art, a pre-charging and a main contactor 15, 16, as well as a pre-charging resistor 17, whereby by way of the contactors 15, 16 the load output of each battery system 5a, 5b, 5c, . . . can each be connected into or disconnected from the common load output 11, i.e. by opening of the contactors 15, 16 and the closing of, for instance, one of the contactors 15 or 16, respectively. The implementation of an additional contactor into the battery system 5a, 5b, 5c, . . . can also be provided, for instance FIG. 1.

Thus and by means of the pre-charging circuit 14, the respective load output of each of the battery systems 5a, 5b, 5c, . . . can be added to or disconnected in a simple manner at the load output 11. For the control of each pre-charging circuit 14 of a battery system 5a, 5b, 5c, . . . , the invention provides, in each case, a battery management system 18 or battery control device, respectively, for each battery system 5a, 5b, 5c, . . . which becomes for instance an integral part therewith. A battery management system 18 controls adding another load output 9 to the common load output 11, or disconnection from the load output 11, respectively, by means of at least one contactor 15, 16 of the respective pre-charging circuit 14 whereby, for the addition, first the pre-charging contactor 15 can be closed and the main contactor 16 can be bypassed, i.e. the addition of a battery system 5a, 5b, 5c, . . . at the common load output 11 takes place after the pre-charging.

For a specifically targeted addition or disconnection of battery systems 5a, 5b, 5c, . . . to a common load output 11, it is provided in this invention that a battery management system 18, in each case, interacts with a control device 19 of the device 1, in particular, interacts with a hybrid control system. By means of the control device 19, switching signals are communicated to the battery management system to open and close the contactors 15, 16, so that the addition or disconnection of the respective load output 9 can be performed in a simple manner. The signals of the control device 19 are communicated, for instance via a Bus 20, to the respective battery management systems 18. In particular, such a designed device 1 enables the connection or disconnect of the load outputs 9 of different battery systems 5a, 5b, 5c, . . . to alternate at the common load output 11 or the inverter 3.

In the inventive method, to operate the device 1, in particular, in the electric drive system 2, a first of the battery systems 5a, 5b, 5c, . . . , for instance the battery system 5a, is disconnected, in a first step, especially depending on the charge state of its energy storage 6, from the common load output 11 by means of the pre-charging device 14. When operating the inverter 3 for a drive purpose, meaning to support the assembly 4 at the load side, that battery system 5a which needs to be disconnected has a low charge level, it is for instance lower than a pre-determined threshold. The load state is especially monitored by the battery management system 18 of the battery system 5a, and is for instance communicated, via the bus 20, to the control device 19.

In a second step, a second battery system, 5a, 5b, 5c, . . . , for instance 5b, is connected to the common load output 11 in this inventive method, by means of its pre-charging device 14, again particularly depending of the charge state of its energy storage 6. During the operation of the inverter 3 especially for the purpose of driving, based on charge states communicated to the control device 19 of the additional energy storages 6, which are monitored by means of the respective battery management systems 18, and their additional battery systems 5a, 5b, 5c, . . . , the control device 19 selects a battery system 5d, where its energy storage 6 has a high charge state, in comparison to the additional battery systems 5a, 5c, 5d, . . . .

The selected battery system 5a, 5b, 5b, . . . , for example the battery system 5b, gets connected by means of its load output 9 to the common load output 11, whereby the added connection utilizes the pre-charging possibility by means of the pre-charging contactor 15 and the pre-charging resistor 17, meaning that the additional battery system is additionally connected in the second step through an increase of the inverter input voltage by means of the pre-charging device 14 of the battery system 5b which is, for instance, to be added.

Therefore by means of the inventive method, a drained battery or energy storage 6, respectively, can be disconnected in a simple manner electrically from the inverter 3, and the new battery or energy storage 6, respectively, can be added in a simple manner for the additional drive of the electric assembly 4.

It is in particular provided in the invention that in each case exactly one of several battery systems 5a, 5b, 5c, . . . during the operation of the inverter 3 connected to the common load output 11, in particular, before the first step, meaning before disconnecting the first battery system 5a and after the second step, meaning after adding the second or additional battery systems 5b, 5c, . . . , respectively. Thus, different charge states of different battery systems 5a, 5b, 5c, . . . do not influence the battery cluster and power electronics, besides the inverter 3, can be omitted. An electronic drive system 2 or the inverter 3, respectively, is hereby always precisely energized by the connected energy storage 6.

In accordance with the invention, switching between a first and a second battery system 5a, 5b, 5c, . . . is carried out during the operation of the inverter 3, preferably in a situation at which no or only a little amount of torque is required for the assembly 4. The reason for this is that a reliable torque cannot be delivered during the switch. The disconnection of the battery systems 5a, 5b, 5c, . . . and the connect of an additional battery system 5a, 5b, 5c, . . . takes place for example, during the hybrid drive, during a change of load, during a shift, in a still-stand phase, at a low torque requirement for the e-machine or the assembly 4, respectively.

In a variation of the inventive method, in particular when the inverter 3 is operating for the purpose of a drive, it is provided that before a first of the battery systems 5a, 5b, 5c, . . . , for instance 5a is disconnected, an additional or third, respectively, of the battery systems 5a, 5b, 5c, . . . , for instance 5c, is connected, in the first step, in parallel to the common load output 11, whereby the third battery system 5c during or after the connection of a second of the battery systems 5a, 5b, 5c, . . . , for instance 5b, is disconnected from the common load output 11, whereby the third battery system 5c in particular is connected or disconnected by means of its pre-charge device 14. At least for the duration of the first and second steps, the third battery system 5c is hereby connected to the common load output 11.

The integration of a third of the battery systems 5a, 5b, 5c, . . . which in particular has an energy storage 6 in the form of a special pre-load battery, into the parallel circuit or the battery cluster, respectively, it is hereby provided that during a switch between a first and a second battery system, i.e. a disconnection of the first and a connection of the second of each to the common load output 11, is inserted and connected so as to stabilize the intermediate circuit which is established by means of the intermediate circuit capacitor 13. Thus, the reduction of load at the inverter 3 during execution of the switch is significantly lower. The third pre-load battery system, for instance 5c, is for instance an energy storage 6 with a low energy content in comparison to the additional energy storages of the traditional battery systems 5a, 5b, 5d, . . . , but a particularly large pre-load resistor 17.

The energy back-feed from the inverter 3 into the common load output 11 or during recuperation, respectively, it is provided, in the first step for the purpose for the charging of an energy storage 6, to disconnect a first battery system 5a, 5b, 5c, . . . , for instance 5a, from the common load output 11, when its energy storage 6 has a high load state in comparison to the load state of traditional energy storages 6 of additional battery systems 5b, 5c, 5d, . . . . The disconnected battery system 5a has been previously—for instance for drive purposes—connected to the common load output 11 due to its large energy storage load state.

In the second step, a second one or an additional one, respectively, of the other battery systems 5a, 5b, 5c, . . . , for instance 5b, is connected at the common load output 11, and its energy storage 6 has a lower charge in comparison to the energy storage 6 of the disconnected battery system 5a. The battery system 5a which needs to be connected is again selected by the control device 19 in conjunction with the battery management system 18, i.e. depending on the load state of the energy storage 6 and added, in particular, by means of the pre-charge circuit 14. The selected battery system 5b is, in particular, the one having the lowest charge state in the energy storage 6 where having the lowest has the lowest charge state in comparison to the others.

It is hereby provided, in accordance with the invention, to sequentially charge or rather connect or disconnect the energy storages 6 of each of the battery systems 5a, 5b, 5c, . . . meaning, starting with the one which has the lowest charge state—in particular to prevent a total discharge—and ending with the one which has the largest charge state. Hereby, it is also provided to connect in each case exactly one energy storage 6, prior to each disconnection or after each connection to the common load output 11.

Charging of the energy storages 6 takes place at the time—in case the recuperated energy is not sufficient—for instance during a hybrid drive through a load point shifting. When the inventive method is applied in a plugin-hybrid vehicle, the charging of the energy storages 6, in particular the battery cells, can also take place at an electrical outlet, also sequentially as previously described.

It is provided in this invention to keep the bus load on the bus 20 low, in particular with a CAN-bus, even with a multitude of participating battery systems 5a, 5b, 5c, . . . . Hereby, the energy storages 6, which are not needed and which are physically disconnected from the common load output 11, are operated in a sleep mode. In this sleep mode the respective battery system 5a, 5b, 5c, . . . transmits with its assigned ID a limited amount of information, for instance its actual charge state (SOC) and, if needed, status information such as voltage, temperature, State of Health. The “sleeping” energy storages 6 or batteries, respectively, need to change into the regular operating mode for the addition on demand, meaning that they need to continually listen, while in the sleep mode, for a wake-up signal on the bus 20.

It is in particular provided in the invention to execute the first step and the second step several times consecutively, whereby the first step and the second step each alternate. Hereby, exactly one energy storage 6 is connected to the common load output 11 after each switch. If required, the suitable energy storage 6 can in each case be connected with the inverter 3.

### REFERENCE CHARACTERS

1 Device
2 Electric Drive System
3 Inverter
3a Input Terminals Inverter
4 Electric Drive Assembly
5a, 5b, 5c, . . . Battery System
6 Energy Storage
6a, 6b Partial Energy Storage
7 Output Energy Storage
8 Housing
9 Load Output Battery System
10 Terminals Battery System
11 Common Load Output
12 Input Inverter
13 Intermediate circuit capacitor
14 Pre-charging Circuit
14a Output Pre-Charging Circuit
15 Pre-Charging Contactor
16 Main Contactor
17 Pre-Charging Resistor
18 Battery Management System
19 Control Device
20 Circuit

1-13. (canceled)

14. A method of operating a device (1) with an electric drive system (2) which has a plurality of battery systems including at least a first battery system (5a) and a second battery system (5b) in a parallel circuit, and each of the plurality of battery systems comprising load outputs (9) that are connected to a common load output (11), each of the plurality of battery systems (5a, 5b) has an energy storage (6) and a pre-load circuit (14) connected therewith, an output (14a) of the pre-load circuit (14) in each case is a load output (9) of the plurality of battery systems (5a, 5b), the load output (9) of each of the plurality of battery systems (5a, 5b) is connectable and disconnectable, via the respective pre-load circuit (14), to the common load output (11), the common load output (11) is energetically directly connected to an inverter input (12), of an inverter (3) of the device (1), by an intermediate circuit capacitor (13), the method comprising the steps of:
disconnecting the first battery system (5a), with the respective pre-load device (14), from the common load output (11), depending on a load state of the respective energy storage (6);
connecting the second battery system (5b) to the common load output (11) with the respective pre-load device (14), depending on a load state of the respective energy storage (6);
connecting the second battery system (5b) by increasing an input voltage of the inverter with the pre-load device (14) of the second battery system (5b) which needs to be connected; and
maintaining a parallel connection of a third battery system (5c) to the common load output (11) to stabilize the input voltage of the inverter, at least for the duration of the disconnection of the first battery system (5a) from the common load output (11) and the connection of the second battery system (5b) to the common load output (11), and the third battery system (5c) being connectable and disconnectable to the common load output (11) by a respective pre-load device (14).

15. The method according to claim 14, further comprising the step of at least one of disconnecting the first battery system (5a) and connecting the second battery system (5b) occurring during the operation of the inverter (3).

16. The method according to claim 14, further comprising the step of always connecting only the third battery system (5c) to the common load output (11) before disconnecting the first battery system from the common load output and after connecting the second battery system to the common load output.

17. The method according to claim 14, further comprising the step of connecting the second battery system to the common load output when its respective energy storage (6) has a higher load level than a load level of the energy storage (6) of the first battery system.

18. The method according to claim 14, further comprising the step of selecting one of the plurality of battery systems for disconnection from the common load output (11), during an energy feedback through the inverter (3) into the common load output (11) for charging an energy storage (6) of one of the plurality of battery systems, when its energy storage (6) has a first load state, and selecting another of the plurality of battery systems for connection to the common load output (11) when its energy storage (6) has a lower load state as compared to the energy storage (6) of the disconnected battery system (5a, 5b, 5c, . . . ).

19. The method according to claim 14, further comprising the step of selecting one of the plurality of battery systems (5a, 5b, 5c, . . . ) as the second battery system for connection to the common load output (11), depending on a load state of its energy storage (6).

20. The method according to claim 14, further comprising the step of connecting and disconnecting the load output (9) of each of the plurality of battery systems (5a, 5b, 5c, . . . ) with a battery management system (18) of the battery system (5a, 5b, 5c, . . . ), and triggering, via the battery management system (18), at least one of the pre-load circuit (14) and a contactor (15, 16) of the plurality of battery systems.

21. The method according to claim 20, further comprising the step of operating the battery management system (18) in conjunction with a control device (19) of the device (1).

22. The method according to claim 14, further comprising the step of alternately connecting and disconnecting the load outputs of the first and the second battery systems to the common load output (11).

23. The method according to claim 14, further comprising the step of using the method to control a motor vehicle.

24. The method according to claim 14, further comprising the step of using the method to control a plug-in hybrid motor vehicle.
